(19) United States
(12) Patent Application Publication
(10) Pub. No.: US 2015/0349533 A1
(43) Pub. Date: Dec. 3, 2015

(54) PHOTOVOLTAIC SYSTEM AND METHOD FOR OPERATING A PHOTOVOLTAIC SYSTEM

(71) Applicant: ROBERT BOSCH GMBH, Stuttgart (DE)

(72) Inventor: Peter Feuerstack, Ludwigsburg (DE)

(21) Appl. No.: 14/649,288

(22) PCT Filed: Dec. 2, 2013
(86) PCT No.: PCT/EP2013/075198

§ 371 Date: Jun. 3, 2015

(30) Foreign Application Priority Data
Dec. 5, 2012 (DE) 10 2012 222 337.1

(51) Int. Cl. H02J 3/38

(52) U.S. Cl. CPC H02J 3/385

(57) ABSTRACT

The invention relates to a photovoltaic system having: an energy storage device for generating a supply voltage at output terminals of the energy storage device, which has at least one parallel-connected energy supply line with one or more energy storage modules connected in series in the energy supply line, each module comprising an energy storage cell module with at least one energy storage cell and a coupling device with a plurality of coupling elements which is designed to selectively connect the energy storage cell module to the respective energy supply line or to bypass the same in the respective energy supply line; a photovoltaic module with one or more photovoltaic cells which is coupled directly to the output terminals of the energy storage device; and a control device which is coupled to the energy storage device and is designed to control the coupling devices of the energy storage modules for adjusting a supply voltage on the basis of the current flow into the one or more photovoltaic cells at the output terminals of the energy storage device.

### BACKGROUND OF THE INVENTION

The invention relates to a photovoltaic system and to a method for operating a photovoltaic system, in particular in the case of island current systems and grid-buffered systems with an energy intermediate store.

It is apparent that, in future, electronic systems which combine new energy storage technologies with electrical drive engineering will be increasingly used both in stationary applications, such as wind turbines or solar installations, for example, and in vehicles, such as hybrid or electric vehicles.

Photovoltaic systems with buffered network support or island current photovoltaic systems usually have an electrical energy store which acts as intermediate store for current supplied from photovoltaic cells. Said energy store is conventionally connected to the photovoltaic modules via a DC chopper controller.

Documents DE 10 2010 027 857 A1 and DE 10 2010 027 861 A1 disclose modularly interconnected battery cells in energy storage devices which can be selectively coupled or decoupled via a suitable actuation of coupling units into the string composed of series-connected battery cells. Systems of this type are known as battery direct converters (BDC). Such systems comprise DC sources in an energy storage module string which are connectable via a pulse-controlled inverter to a DC-voltage intermediate circuit for electrical energy supply of an electric machine or an electric grid.

There is therefore a demand for options which are inexpensive, efficient and can be manufactured with little implementation expenditure in terms of technology in order to achieve photovoltaic systems with island current supply and/or grid buffering in which a DC chopper controller between electrical energy store and photovoltaic module can be dispensed with.

### SUMMARY OF THE INVENTION

According to one aspect, the present invention provides a photovoltaic system, having an energy storage device for generating a supply voltage at output connections of the energy storage device, which has at least one parallel-connected energy supply string with in each case one or more energy storage modules connected in series in the energy supply string, said energy storage modules comprising in each case an energy storage cell module with at least one energy storage cell and a coupling device with a multiplicity of coupling elements, which coupling device is configured to selectively connect the energy storage cell module into the respective energy supply string or to bypass said energy storage cell module in the respective energy supply string, a photovoltaic module with one or more photovoltaic cells, which photovoltaic module is directly coupled to the output connections of the energy storage device, and a control device which is coupled to the energy storage device and which is configured to actuate the coupling devices of the energy storage modules to adjust a supply voltage on the basis of the flow of current in the one or more photovoltaic cells at the output connections of the energy storage device.

According to another aspect, the present invention provides a method for operating a photovoltaic system according to the invention, having the steps of calculating a present flow of current in the one or more photovoltaic cells, actuating the coupling devices of a first number of energy storage modules of the energy storage device to connect the respective energy storage cell modules into the energy supply string, actuating the coupling devices of a second number of energy storage modules of the energy storage device to bypass the respective energy storage cell modules in the energy supply string, and determining the first and second number of energy storage modules of the energy storage device on the basis of the calculated present flow of current in the one or more photovoltaic cells.

A concept of the present invention is to couple an energy storage device with one or more modularly constructed energy supply strings composed of a series connection of energy storage modules directly to a photovoltaic module, and to adapt the output voltage of the energy storage device to the requirements of the photovoltaic module by modularly actuating the energy storage modules. In this case, maximum power point tracking (MPPT) advantageously takes place via the corresponding setting of the output voltage of the energy storage device, with the result that the photovoltaic module always operates in the optimum power region. For this purpose, the energy storage device can be actuated on the basis of the present flow of current in the photovoltaic cells of the photovoltaic module.

Advantageously, the modular construction of the energy storage strings enables a fine gradation of the total output voltage of the energy storage device, for example by the phase-shifted actuation of the respective coupling units for the individual energy storage cell modules or the pulse-width-modulated actuation of individual energy storage modules. As a result of this, the voltage for the MPPT can be adjusted very precisely.

The energy storage modules of the energy supply strings can also be exchanged in a cyclic fashion in the turn-on operation in order to be advantageously able to achieve an even loading of the energy storage cells. Furthermore, in the event of a fault, individual energy storage modules can be selectively removed from the module rotation without the fundamental functionality of the overall system being impaired.

By using a modularly constructed energy storage device, it is possible to simplify the battery management system since only a modular actuation is necessary. In addition, the energy storage device can be easily scaled by the number of energy supply strings or the number of the installed energy storage modules per energy supply string being modified without further adaption problems. As a result of this, different variants of photovoltaic modules can be cost-effectively supported. In particular, the number of energy storage modules can be adapted such that the maximum possible voltage for the photovoltaic module remains adjustable, even in the case of completely discharged energy storage cells of the energy storage cell modules, by the inclusion of all of the energy storage modules.

According to an embodiment of the photovoltaic system according to the invention, the energy storage device may also have at least one storage inductance, which is coupled between one of the output connections of the energy storage device and one of the energy supply strings.

According to another embodiment of the photovoltaic system according to the invention, the energy storage device may also have a DC-voltage intermediate circuit, which is coupled to the output connections of the energy storage device and is connected in parallel with the energy supply strings.

According to another embodiment of the photovoltaic system according to the invention, the photovoltaic system may also have an inverter, which is coupled to the output connections of the energy storage device and to the photovoltaic module.

According to another embodiment of the photovoltaic system according to the invention, the inverter may be configured to be fed with a DC voltage from the energy storage device and/or from the photovoltaic module and to convert the DC voltage into a single-phase or polyphase AC voltage. This advantageously enables current to be fed into a supply grid from the photovoltaic cells and/or the energy storage device.

According to another embodiment of the photovoltaic system according to the invention, the control device may also be configured to calculate the present power requirements of the inverter and to actuate the coupling devices of the energy storage modules on the basis of the calculated power requirements to adapt the output voltage of the energy storage device. This is particularly advantageous in operating phases in which no energy is drawn or can be drawn from the photovoltaic cells, for example during darkness.

According to another embodiment of the photovoltaic system according to the invention, the coupling devices of the energy storage modules may comprise a half-bridge circuit or a full-bridge circuit composed of the multiplicity of coupling elements.

According to another embodiment of the photovoltaic system according to the invention, the photovoltaic system may also have a diode which is coupled between one of the output connections of the energy storage device and the photovoltaic module to prevent a return flow of current in the photovoltaic cells.

Further features and advantages of embodiments of the invention emerge from the following description with reference to the appended drawings.

### BRIEF DESCRIPTION OF THE DRAWINGS

In the drawings:

FIG. 1 shows a schematic illustration of an energy storage device according to an embodiment of the present invention;

FIG. 2 shows a schematic illustration of an exemplary embodiment of an energy storage module of an energy storage device according to another embodiment of the present invention;

FIG. 3 shows a schematic illustration of another exemplary embodiment of an energy storage module of an energy storage device according to another embodiment of the present invention;

FIG. 4 shows a schematic illustration of a photovoltaic system having a photovoltaic module and an energy storage device according to another embodiment of the present invention;

FIG. 5 shows a schematic illustration of a current-voltage characteristic curve and a power characteristic curve of a photovoltaic module according to another embodiment of the present invention; and

FIG. 6 shows a schematic illustration of a method for operating a photovoltaic system according to another embodiment of the present invention.

### DETAILED DESCRIPTION

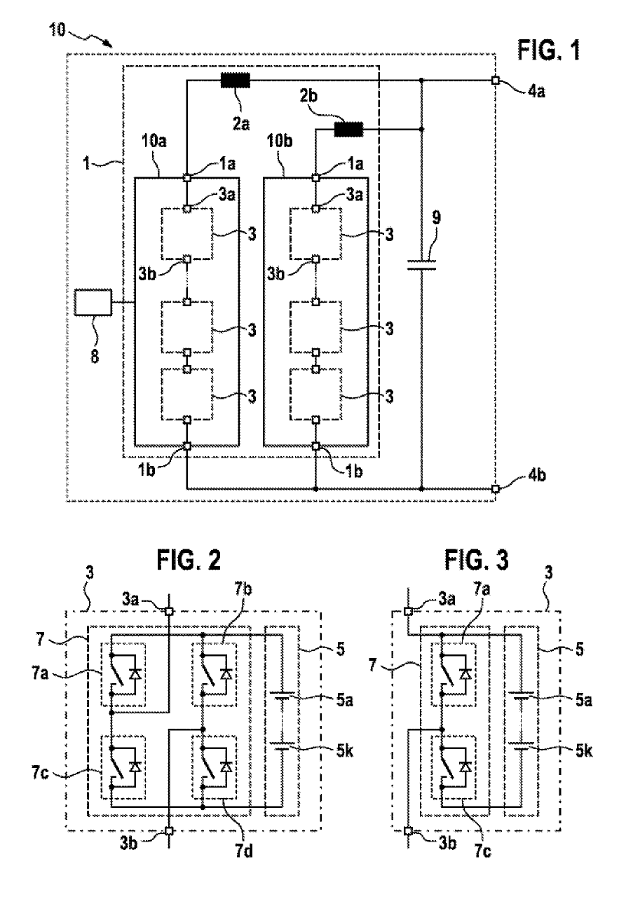

FIG. 1 shows an energy storage device 10 for providing a supply voltage through energy supply strings 10a, 10b, which are connectable in parallel, between two output connections 4a, 4b of the energy storage device 10. The energy supply strings 10a, 10b each have string connections 1a and 1b. The energy storage device 10 has at least two parallel-connected energy supply strings 10a, 10b. By way of example, the number of energy supply strings 10a, 10b is two in FIG. 1, wherein any other greater number of energy supply strings 10a, 10b is likewise possible, however. In this case, it may equally also be possible to connect only one energy supply string 10a between the string connections 1a and 1b, which in this case form the output connections of the energy storage device 10.

Since the energy supply strings 10a, 10b can be connected in parallel via the string connections 1a, 1b of the energy supply strings 10a, 10b, the energy supply strings 10a, 10b act as current sources with variable output current. The output currents of the energy supply strings 10a, 10b add together in this case at the output connection 4a of the energy storage device 10 to give a total output current.

The energy supply strings 10a, 10b can in this case each be coupled to the output connection 4a of the energy storage device 1 via storage inductances 2a, 2b. The storage inductances 2a, 2b can be, for example, lumped or distributed components. Alternatively, parasitic inductances of the energy supply strings 10a, 10b can also be used as storage inductances 2a, 2b. By appropriate actuation of the energy supply strings 10a, 10b, the flow of current in the DC-voltage intermediate circuit 9 can be controlled. If the average voltage upstream of the storage inductances 2a, 2b is higher than the instantaneous intermediate circuit voltage, current flows into the DC-voltage intermediate circuit 9; however, if the average voltage upstream of the storage inductances 2a, 2b is lower than the instantaneous intermediate circuit voltage, current flows into the energy supply string 10a or 10b. The maximum current in this case is limited by the storage inductances 2a, 2b in cooperation with the DC-voltage intermediate circuit 9.

In this way, each energy supply string 10a and 10b acts as variable current source via the storage inductances 2a, 2b, which variable current sources are suitable both for a parallel circuit and also for creating current intermediate circuits. In the case of a single energy supply string 10a, the storage inductance 2a can also be dispensed with, with the result that the energy supply string 10a is directly coupled between the output connections 4a, 4b of the energy storage device 1.

Each of the energy supply strings 10a, 10b has at least two series-connected energy storage modules 3. By way of example, the number of energy storage modules 3 per energy supply string is two in FIG. 1, wherein any other number of energy storage modules 3 is likewise possible, however. Preferably, each of the energy supply strings 10a, 10b comprises the same number of energy storage modules 3 here, wherein it is also possible, however, for each energy supply string 10a, 10b to provide a different number of energy storage modules 3. The energy storage modules 3 each have two output connections 3a and 3b, via which an output voltage of the energy storage modules 3 can be provided.

Exemplary embodiments of the energy storage modules 3 are shown in more detail in FIGS. 2 and 3. The energy storage modules 3 each comprise a coupling device 7 having a plurality of coupling elements 7a and 7c and, optionally, 7b and 7d. The energy storage modules 3 also each comprise an energy storage cell module 5 having one or more series-connected energy storage cells 5a, 5k.

In this case, by way of example, the energy storage cell module 5 can have series-connected batteries 5a to 5k, for example lithium-ion batteries or lithium-ion rechargeable batteries. Alternatively or in addition, supercapacitors or double-layer capacitors can also be used as energy storage cells 5a to 5k. In this case, the number of energy storage cells 5a to 5k in the energy storage module 3 shown in FIG. 2 is, by way of example, two, wherein any other number of energy storage cells 5a to 5k is likewise possible, however.

The coupling device 7 is designed in FIG. 2 by way of example as a full-bridge circuit with in each case two coupling elements 7a and 7c and two coupling elements 7b and 7d. The coupling elements 7a, 7b, 7c, 7d can in this case each have an active switching element, for example a semiconductor switch, and a freewheeling diode connected in parallel with said switching element. The semiconductor switches can have, for example, field-effect transistors (FETs). In this case, the freewheeling diodes can also be integrated in the semiconductor switches in each case.

The coupling elements 7a, 7b, 7c, 7d in FIG. 2 can be actuated, for example by means of the control device 8 in FIG. 1, such that the energy storage cell module 5 is selectively connected between the output connections 3a and 3b or such that the energy storage cell module 5 is bypassed. Therefore, by suitable actuation of the coupling devices 7, individual ones of the energy storage modules 3 can be integrated into the series circuit of an energy supply string 10a, 10b in a targeted manner.

With reference to FIG. 2, the energy storage cell module 5 can be connected, by way of example, in the forward direction between the output connections 3a and 3b by the active switching element of the coupling element 7d and the active switching element of the coupling element 7a being shifted into a closed state while the two remaining active switching elements of the coupling elements 7b and 7c are shifted into an open state. In this case, the module voltage is present between the output terminals 3a and 3b of the coupling device 7. A bypassing state can be adjusted, for example, by the two active switching elements of the coupling elements 7a and 7b being shifted into a closed state while the two active switching elements of the coupling elements 7c and 7d are kept in an open state. A second bypassing state can be adjusted, for example, by the two active switches of the coupling elements 7c and 7d being shifted into a closed state while the active switching elements of the coupling elements 7a and 7b are kept in an open state. In both bypassing states, a voltage of 0 is present between the two output terminals 3a and 3b of the coupling device 7. Likewise, the energy storage cell module 5 can be connected in the reverse direction between the output connections 3a and 3b of the coupling device 7 by the active switching elements of the coupling elements 7b and 7c being shifted into a closed state while the active switching elements of the coupling elements 7a and 7d are shifted into an open state. In this case, the negative module voltage is present between the two output terminals 3a and 3b of the coupling device 7.

The total output voltage of an energy supply string 10a, 10b can in each case be adjusted here in steps, wherein the number of steps scales with the number of energy storage modules 3. In the case of a number n of first and second energy storage modules 3, the total output voltage of the energy supply string 10a, 10b can be adjusted in 2n+1 steps between the negative total voltage and the positive total voltage of the energy supply string 10a, 10b. The individual energy storage modules 3 which in this case each contribute to the total output voltage of the energy supply string 10a, 10b, can be cycled through or exchanged in another adjustable way in order to keep the loading on the individual energy storage cell modules 5 during operation as even as possible.

FIG. 3 shows another exemplary embodiment of an energy storage module 3. The energy storage module 3 shown in FIG. 3 differs from the energy storage module 3 shown in FIG. 2 only in that the coupling device 7 has two coupling elements instead of four, which are interconnected in a half-bridge circuit instead of in a full-bridge circuit.

In the illustrated variant embodiment, the active switching elements of the coupling devices 7 can be embodied as power semiconductor switches, for example in the form of IGBTs (insulated-gate bipolar transistors), JFETs (junction field-effect transistors) or MOSFETs (metal-oxide semiconductor field-effect transistors).

In order to keep an average voltage value between two voltage steps predefined by the gradation of the energy storage cell modules 5 the coupling elements 7a, 7c and, optionally, 7b and 7d of an energy storage module 3 can be actuated in a clocked manner, for example with pulse-width-modulated (PWM) operation, with the result that the energy storage module 3 in question supplies a module voltage on average over time which can have a value of between zero and the maximum possible module voltage determined by the energy storage cells 5a to 5k. The coupling elements 7a, 7b, 7c, 7d can in this case be actuated, for example, by a control device, such as the control device 8 in FIG. 1, which control device is configured to perform, for example, current regulation with an underlying voltage control, with the result that a stepwise turn-on or turn-off of individual energy storage modules 3 can take place.

The energy storage device 10 can also have a DC-voltage intermediate circuit 9 which is coupled to the output connections 4a and 4b of the energy storage device 10 and is connected in parallel with the energy supply strings 10a, 10b. Owing to the cooperation of the storage inductances 2a, 2b and the DC-voltage intermediate circuit 9, output voltages and output currents of the energy storage device 10 can be kept as free from fluctuations, that is to say without current or voltage ripple, as possible.

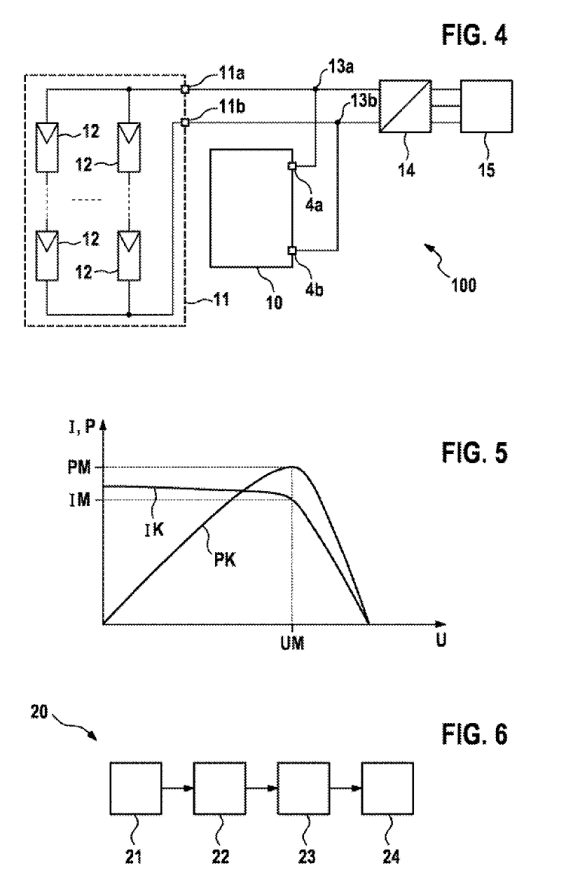

FIG. 4 shows a schematic illustration of an exemplary photovoltaic system 100. The photovoltaic system 100 has a photovoltaic module 11 with one or more photovoltaic cells 12, which can be interconnected in an array of photovoltaic cells 12, for example. The number of photovoltaic cells 12 is illustrated by way of example with four in FIG. 4, wherein any other number is likewise possible, however.

The photovoltaic module 11 supplies electrical energy at outputs 11a and 11b in accordance with a current-voltage characteristic curve IK, as illustrated by way of example in FIG. 5. The photovoltaic module 11 supplies the maximum power PM, as illustrated by way of example on the power characteristic curve PK, at a point with the voltage UM and the associated current strength IM.

The photovoltaic system 100 comprises an energy storage device 10 the output connections 4a and 4b of which are directly coupled to the outputs 11a and 11b of the photovoltaic module 11 at the nodes 13a and 13b. In particular, an intermediately connected DC splitter can be dispensed with here. The photovoltaic system 100 can also comprise an inverter 14, which converts a DC voltage received from the energy storage device 10 and/or from the photovoltaic module 11 into a single-phase or polyphase AC voltage for an electric machine or an energy supply grid 15.

The photovoltaic system 100 can also comprise a control device 8, which is connected to the energy storage device 10 and by means of which the energy storage device 10 can be controlled in order to provide the desired total output voltage of the energy storage device 10 at the respective output connections 4a and 4b.

The total output voltage of the energy storage device 1 is preferably variable over such a voltage range which means that a suitable output voltage can be adjusted for each operating voltage of the photovoltaic module 11. This can be done via an appropriate selection of the number of energy supply strings 10a and 10b and/or the number of energy storage modules 3 per energy supply string 10a and 10b, with the result that, even in the case of the lowest provided state of charge of the energy storage cells 5a to 5k that of the energy storage modules 3, an appropriate output voltage can be provided, which corresponds to the maximum achievable voltage in the photovoltaic module 11.

By way of example, the control device 8 can store predetermined characteristic maps of the parameter ranges for the output voltage of the energy storage device 1 and use them to actuate the coupling devices 7 of the energy storage modules 3 on the basis of operating parameters calculated during the operation of the drive system 100, such as state of charge of the energy storage cells 5a to 5k, operating voltage of the photovoltaic module 11, state of charge of the DC-voltage intermediate circuit 9, required power of the inverter 14 or other parameters. By way of example, the characteristic maps can correspond to the characteristic maps illustrated in FIG. 5. The control device 8 can then adjust the energy storage device 1 to the desired output voltage by appropriate actuation of one or more energy storage modules 3. In this case, the control device 8 can, in particular, implement control to maximum power (MPPT) of the photovoltaic module 11.

In addition, the present power requirement of the photovoltaic system 100 can be detected at the output of the inverter 14 by the control device 8, with the result that the energy storage device 10 acts as grid buffer for the inverter 14, in particular in operating phases of the photovoltaic module 11 in which the photovoltaic cells 12 do not or cannot supply any power.

FIG. 6 is a schematic illustration of an exemplary method 20 for operating a photovoltaic system, in particular a photovoltaic system 100 having an energy storage device 10 and a photovoltaic module 11, as explained in conjunction with FIGS. 1 to 5.

In a first step 21, a present flow of current 1K into the one or more photovoltaic cells 12 is calculated. In steps 22 and 23, the coupling devices 7 of a first number of energy storage modules 3 of the energy storage device 10 are actuated to connect the respective energy storage cell modules 5 into the energy supply string 10a or 10b and the coupling devices 7 of a second number of energy storage modules 3 of the energy storage device 10 are actuated to bypass the respective energy storage cell modules 5 in the energy supply string 10a or 10b.

Then, in step 24, the first and second numbers of energy storage modules 3 of the energy storage device 10 can be determined on the basis of the calculated present flow of current 1K into the one or more photovoltaic cells 12.

1. A photovoltaic system, comprising:
an energy storage device for generating a supply voltage at output connections of the energy storage device, the energy storage device having at least one parallel-connected energy supply string, each parallel-connected energy supply string including one or more energy storage modules connected in series in the energy supply string, said energy storage modules comprising in each case an energy storage cell module, the energy storage cell module including at least one energy storage cell and a coupling device with a multiplicity of coupling elements, the coupling device configured to selectively connect the energy storage cell module into the respective energy supply string or to bypass said energy storage cell module in the respective energy supply string;
a photovoltaic module with one or more photovoltaic cells, the photovoltaic module directly coupled to the output connections of the energy storage device; and
a control device coupled to the energy storage device, the control device configured to actuate the coupling devices of the energy storage modules to adjust a supply voltage on the basis of the flow of current in the one or more photovoltaic cells at the output connections of the energy storage device.

2. The photovoltaic system as claimed in claim 1, further comprising:
at least one storage inductance coupled between one of the output connections of the energy storage device and one of the energy supply strings.

3. The photovoltaic system as claimed in claim 1, further comprising:
a DC-voltage intermediate circuit coupled to the output connections of the energy storage device and connected in parallel with the energy supply strings.

4. The photovoltaic system as claimed in claim 1, further comprising:
an inverter coupled to the output connections of the energy storage device and to the photovoltaic module.

5. The photovoltaic system as claimed in claim 4, wherein the inverter is configured to receive a DC voltage from the energy storage device, the photovoltaic module, or both and to convert the DC voltage into a single-phase or polyphase AC voltage.

6. The photovoltaic system as claimed in claim 4, wherein the control device is configured to calculate the present power requirements of the inverter and to actuate the coupling devices of the energy storage modules on the basis of the calculated power requirements to adapt the output voltage of the energy storage device.

7. The photovoltaic system as claimed in claim 1, wherein the coupling devices of the energy storage modules comprise a half-bridge circuit or a full-bridge circuit composed of the multiplicity of coupling elements.

8. The photovoltaic system as claimed in claim 1, further comprising:
a diode coupled between one of the output connections of the energy storage device and the photovoltaic module to prevent a return flow of current in the photovoltaic cells.

9. A method for operating a photovoltaic system as claimed in claim 1, comprising the steps of:
calculating a present flow of current in the one or more photovoltaic cells;
actuating the coupling devices of a first number of energy storage modules of the energy storage device to connect the respective energy storage cell modules into the energy supply string;
actuating the coupling devices of a second number of energy storage modules of the energy storage device to bypass the respective energy storage cell modules in the energy supply string; and
determining the first and second number of energy storage modules of the energy storage device on the basis of the calculated present flow of current in the one or more photovoltaic cells.
